(19) United States
(12) Patent Application Publication
(10) Pub. No.: US 2024/0187869 A1
(43) Pub. Date: Jun. 6, 2024

(54) SYSTEM AND METHOD FOR SMALL CELL SITE LOCATION IDENTIFICATION FOR CELLULAR NETWORKS

(71) Applicant: RAKUTEN SYMPHONY SINGAPORE PTE. LTD., Singapore (SG)

(72) Inventors: Sudeep JAIN, Indore (IN); Durgesh RATHORE, Indore (IN); Shanu KORE, Indore (IN); Keshav SHARMA, Indore (IN)

(73) Assignee: RAKUTEN SYMPHONY SINGAPORE PTE. LTD., Singapore (SG)

(21) Appl. No.: 17/799,860

(22) PCT Filed: Jun. 15, 2022
(86) PCT No.: PCT/US2022/033535

§ 371 Date: Aug. 15, 2022

(51) Int. Cl. H04W 16/18; H04W 16/32; H04W 24/02

(52) U.S. Cl. CPC H04W 16/18; H04W 16/32; H04W 24/02

(57) ABSTRACT

A system and method for identifying cell site locations within a cellular network. The method includes: receiving a list of one or more first cells with respect to a network, applying a first set of conditions with respect to the first cells; identifying the first cells that meet the first set of conditions, and placing the identified first cells within one or more first grids; designating one or more first network congestion severity identifiers to the first grids. The method can further include determining if a centroid of one or more grids within the first grids fall within a first pre-defined distance, creating one or more first tables or matrices based on the designated first network congestion severity identifiers with respect to the first grids, designating one or more second network congestion severity identifiers to the first tables or matrices.

### TECHNICAL FIELD

The present disclosure relates to identifying site locations for small cell deployment within a cellular network.

### BACKGROUND

Cellular networks generally require a significant amount of bandwidth during peak times and a lower amount of bandwidth during other times. Network congestion can occur when a network node or link carries more data than it can handle, which reduces the quality of service. The effect of this congestion and lower bandwidth can include queueing delay, packet loss, blocking new connections, etc. Deploying dedicated high-speed links, such as fiber, or high-speed microwave to every base station/macro-cell or adding additional macro-cells, in order to improve bandwidth can be costly and inefficient. To counter this, cellular networks can typically employ a small cell network in addition to their existing macro-layer network or macro-cells to improve network availability, coverage, quality, resilience, and throughput, particularly with respect to “5G” networks. Such small cells can be used to offload traffic from the macro-cells, or from the macro layers within the network. Generally, small cells are low-powered radio access nodes employed by wireless carriers to expand the density of existing wireless network, such as that of macro cells or base stations. These small cells can operate within a licensed or unlicensed spectrum, and can generally include femtocells, picocells, and microcells, among others. In addition, such small cells can be installed in various indoor and outdoor locations, such as on buildings, street posts, poles, facades, and on ceilings within indoor spaces, among other places. Currently, there is no effective or efficient way of locating and identifying potential small cell site locations to help for deployment by a radio access network provider in order to improve capacity deficits at the macro-cell layer. Hence, what is needed is a method and system that can efficiently and accurately locate and suggest small cell site locations based on low-capacity zones generated from macro-cell service area predictions and further provide a visual representation of such small cell sites on a map.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

A system and method are disclosed that can efficiently and accurately identify and suggest small cell site locations based on low-capacity zones generated from macro-cell service area predictions, and further provide a visual representation of such small cell sites on a map.

According to example embodiments, a system and method of identifying cell site locations within a cellular network includes: receiving a list of one or more first cells with respect to a network; applying a first set of conditions with respect to the first cells; identifying the first cells that meet the first set of conditions; placing the identified first cells within one or more first grids; designating one or more first network congestion severity identifiers to the first grids; determining if a centroid of one or more grids within the first grids fall within a first pre-defined distance; creating one or more first tables or matrices based on the designated first network congestion severity identifiers with respect to the first grids; designating one or more second network congestion severity identifiers to the first tables or matrices; and identifying, based on the second network congestion severity identifiers, the first tables or matrices for cell site location identification.

The first tables or matrices may further be based on geographic regions, locations, or levels. Further, the first cells may include cells within the network that are one or more macro-cells, cells on a macro layer within the network, or base station transceivers.

The first network congestion severity identifiers and second network severity identifiers may each include a first rank or degree having a range of 75%-100%, second rank or degree having a range of 50%-75%, a third rank or degree having a range of 25%-50%, and a fourth rank or degree having a range of 0%-25%. Here, the step of identifying, based on the second network congestion severity identifiers, the first tables or matrices for cell site location identification, may further include identifying, based on the first rank of the second network congest severity identifiers, the first tables or matrices for cell site location identification.

The system and method can further include determining one or more first sub-grids from each of the first tables or matrices based on priority within the network and, upon determining the one or more first sub-grids from each of the first tables or matrices based on priority within the network, identifying one or more cell site location candidates within the one or more first sub-grids.

The system and method may further include wherein the identified one or more cell site location candidates do not fall within a predefined distance.

The system and method may consolidating a list of the identified one or more cell site location candidates within the one or more first sub-grids; and identifying one or more candidate structures from the consolidated list having a height greater than an average structure height. Here, the priority may be further based on a priority score comprised of a weighted radio frequency priority score and weighted transmission priority score.

According to example embodiments, an apparatus for identifying cell site locations within a cellular network includes: a memory storage storing computer-executable instructions; and a processor communicatively coupled to the memory storage, wherein the processor is configured to execute the computer-executable instructions and cause the apparatus to receive, from a central server, a list of one or more first cells with respect to a network; apply a first set of conditions with respect to the first cells; identify the first cells that meet the first set of conditions; place the identified first cells within one or more first grids; designate one or more first network congestion severity identifiers to the first grids; determine if a centroid of one or more grids within the first grids fall within a first pre-defined distance; create one or more first tables or matrices based on the designated first network congestion severity identifiers with respect to the first grids; designate one or more second network congestion severity identifiers to the first tables or matrices; and identify, based on the second network congestion severity identifiers, the first tables or matrices for cell site location identification.

The first tables or matrices may be further based on geographic regions, locations, or levels. Further, the first cells may include cells within the network that are one or more macro-cells, cells on a macro layer within the network, or base station transceivers.

The first network congestion severity identifiers and second network severity identifiers may each include a first rank or degree having a range of 75%-100%, second rank or degree having a range of 50%-75%, a third rank or degree having a range of 25%-50%, and a fourth rank or degree having a range of 0%-25%.

In identifying, based on the second network congestion severity identifiers, the first tables or matrices for cell site location identification, the computer-executable instructions, when executed by the processor, may further cause the apparatus to identify, based on the first rank of the second network congest severity identifiers, the first tables or matrices for cell site location identification.

The computer-executable instructions, when executed by the processor, may further cause the apparatus to determine one or more first sub-grids from each of the first tables or matrices based on priority within the network.

The computer-executable instructions, when executed by the processor, may further cause the apparatus to, upon determining the one or more first sub-grids from each of the first tables or matrices based on priority within the network, identify one or more cell site location candidates within the one or more first sub-grids.

The computer-executable instructions, wherein the identified one or more cell site location candidates do not fall within a predefined distance.

The computer-executable instructions, when executed by the processor, may further cause the apparatus to consolidate a list of the identified one or more cell site location candidates within the one or more first sub-grids; and identify one or more candidate structures from the consolidated list having a height greater than an average structure height.

According to embodiments, a non-transitory computer-readable medium includes computer-executable instructions for identifying cell site locations within a cellular network by an apparatus, wherein the computer-executable instructions, when executed by at least one processor of the apparatus, cause the apparatus to receive a list of one or more first cells with respect to a network; apply a first set of conditions with respect to the first cells; identify the first cells that meet the first set of conditions; place the identified first cells within one or more first grids; designate one or more first network congestion severity identifiers to the first grids; determine if a centroid of one or more grids within the first grids fall within a first pre-defined distance; create one or more first tables or matrices based on the designated first network congestion severity identifiers with respect to the first grids; designate one or more second network congestion severity identifiers to the first tables or matrices; and identify, based on the second network congestion severity identifiers, the first tables or matrices for cell site location identification.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other aspects, features, and aspects of embodiments of the disclosure will be apparent from the following description taken in conjunction with the accompanying drawings, in which:

FIG. 1 illustrates a general network architecture according to one or more embodiments;

FIG. 2 is a block diagram of a system for identifying small cell site locations according to one or more embodiments;

FIG. 3 is a flowchart of a SCLI method according to one or more embodiments;

FIG. 4 illustrates an example screen of a graphical user interface map of the SCLI according to one or more embodiments;

FIG. 5 illustrates another example screen of a graphical user interface map of the SCLI according to one or more embodiments;

FIG. 6 illustrates another example screen of a graphical user interface map of the SCLI according to one or more embodiments; and

FIG. 7 illustrates another example screen of a graphical user interface map of the SCLI according to one or more embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In one implementation of the disclosure described herein, a display page may include information residing in the computing device's memory, which may be transmitted from the computing device over a network to a central database center and vice versa. The information may be stored in memory at each of the computing device, a data storage resided at the edge of the network, or on the servers at the central database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones, personal computers, tablets, servers, laptop computers, personal digital assistants (PDAs), roaming devices, wireless devices (such as a wireless email device or other device capable of communicating wirelessly with a computer or communications network), or any other type of network device that may communicate over a network and handle electronic transactions.

Phrases and terms similar to “software”, “application”, “app”, and “firmware” may include any non-transitory computer readable medium storing thereon a program, which when executed by a computer, causes the computer to perform a method, function, or control operation.

Phrases and terms similar to “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also include a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, components, features, options, and/or attributes of the disclosure described herein. For example, the portal can be a web page accessed with a web browser, mobile device application, or any application or software residing on a computing device.

A small cell site location identification (“SCLI”) method, system, apparatus, and computer-readable medium according to example embodiments may identify small cell site locations that present the least cost and the highest performance in terms of traffic absorption and capacity provisions, such that highly utilized cells (“HUC” or “HUCs”) can be offloaded. As used herein, an HUC can be any cell, macro-cell, small cell, or otherwise, preferably a macro-cell or base station, that is highly utilized within a network, has above average utilization or traffic or congestion within a network, has a degree of utilization or congestion that is above a pre-defined utilization or congestion parameter, or has a degree of utilization or congestion that meets or is above an industry recognized standard with respect to network cell utilization. Here, an algorithm of the SCLI method can run periodically and provide information on newly identified and suggested small cells, which helps a radio frequency (“RF”) optimization team to reduce network congestion. Improving network congestion via the SCLI method of one or more embodiments described herein can result in increased customer satisfaction and lower customer churn rate, among other advantages.

In addition, the SCLI method and system according to example embodiments can efficiently and effectively report the results of identified or potential small cell sites to a user within a graphical user interface (“GUI”) portal, and more specifically within a graphical map of the suggested small cell site locations. In addition, the GUI portal of one or more embodiments described herein can display and identify, on the map, based on certain geographical regions, the small cell site locations, structures, poles, outdoor spaces, or buildings, among others, with respect to a particular carrier or network which can be viewed from various zoom levels, such as from 100 km to 500 km, among others. In addition, the SCLI method of one or more embodiments described herein can support multiple vendors or wireless carrier or network providers.

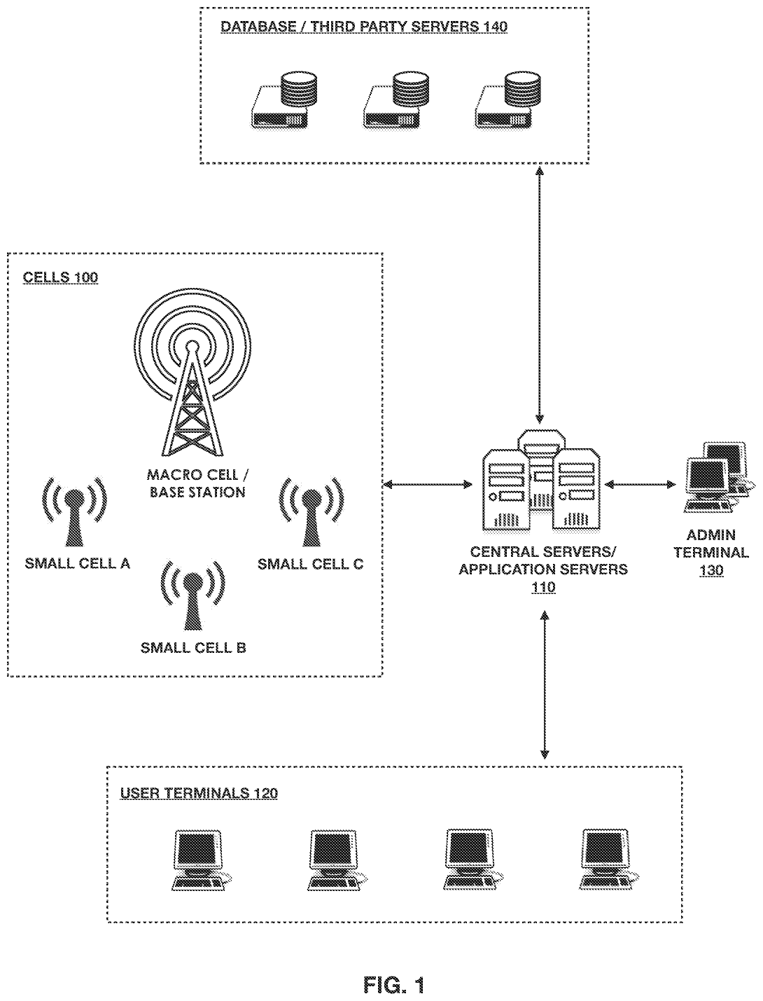

FIG. 1 illustrates a general network architecture according to one or more embodiments. Referring to FIG. 1, cells 100 can be in bi-directional communication over a network with central servers, databases, or application servers 110 of the disclosure described herein. In particular, cells 100 can include any number of macro-cells, base transceivers, base stations, and small cells or nodes. For example, it is contemplated within the scope of the present disclosure described herein that there may be any number of macro-cells that communicate with each other and/or with their corresponding small cells to improve and expand cellular and wireless network (e.g., 5G, 4G, Long-Term Evolution, etc.) coverage, reliability, throughput, and quality of the macro-cells or the network provider within a given geographical region or area. It is also contemplated within the scope of the present disclosure described herein that any of cells 100, including macro-cells and small cells and any variations thereof, such as femtocells, picocells, and microcells, may be referred to herein as cells. As shown herein, for exemplary purposes, small cells A, B, and C may be in communication with a central or main macro-cell (or multiple macro-cells) or base station tower network.

Still referring to FIG. 1, one or more user terminals 120 can also be in bi-directional communication over a network with central servers 110. Specifically, central servers 110 can receive and process user requests with respect to an SCLI engine and algorithm of the disclosure described herein and further report and present the results to each user terminal 120. Here, each user terminal 120 may further access and view the GUI portal and map with respect to the SCLI process and system of the disclosure described herein. In addition, an admin terminal 130 may also be in bi-directional communication with central servers 110 to manage and monitor various types of network data, known performance indicators (“KPIs”), credentials, user privileges, and the like. Further, the SCLI process and system of the disclosure described herein may also include one or more databases and third-party servers 140 in bi-directional communication over a network with central servers 110. Here, servers 140 can provide various types of data storage, data streams, data feeds, and/or provide various types of third-party support services to central servers 110. However, it is contemplated within the scope of the present disclosure described herein that the SCLI process and system of one or more embodiments described herein can include any type of general network architecture.

Still referring to FIG. 1, one or more of servers and terminals 110-140 may include a personal computer (PC), a printed circuit board including a computing device, a mini-computer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device.

In some embodiments, as shown in FIG. 1, one or more servers and terminals 110-140 may include a set of components, such as a processor, a memory, a storage component, an input component, an output component, a communication interface, and a JSON-based UI rendering component. The set of components of the device may be communicatively coupled via a bus.

The bus may include one or more components that permit communication among the set of components of one or more of servers and terminals 110-140. For example, the bus may be a communication bus, a cross-over bar, a network, or the like. The bus may be implemented using single or multiple (two or more) connections between the set of components of one or more of servers and terminals 110-140. The disclosure is not limited in this regard.

One or more of servers and terminals 110-140 may include one or more processors. The one or more processors may be implemented in hardware, firmware, and/or a combination of hardware and software. For example, the one or more processors may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The one or more processors also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The one or more processors may control overall operation of one or more of servers and terminals 110-140 and/or of the set of components of one or more of servers and terminals 110-140 (e.g., memory, storage component, input component, output component, communication interface, rendering component).

One or more of servers and terminals 110-140 may further include memory. In some embodiments, the memory may comprise a random access memory (RAM), a read only memory (ROM), an electrically erasable programmable ROM (EEPROM), a flash memory, a magnetic memory, an optical memory, and/or another type of dynamic or static storage device. The memory may store information and/or instructions for use (e.g., execution) by the processor.

A storage component of one or more of servers and terminals 110-140 may store information and/or computer-readable instructions and/or code related to the operation and use of one or more of servers and terminals 110-140. For example, the storage component may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

One or more of servers and terminals 110-140 may further include an input component. The input component may include one or more components that permit one or more of servers and terminals 110-140 to receive information, such as via user input (e.g., a touch screen, a keyboard, a keypad, a mouse, a stylus, a button, a switch, a microphone, a camera, and the like). Alternatively or additionally, the input component may include a sensor for sensing information (e.g., a global positioning system (GPS) component, an accelerometer, a gyroscope, an actuator, and the like).

An output component of any one or more of servers and terminals 110-140 may include one or more components that may provide output information from the device (e.g., a display, a liquid crystal display (LCD), light-emitting diodes (LEDs), organic light emitting diodes (OLEDs), a haptic feedback device, a speaker, and the like).

One or more of servers and terminals 110-140 may further include a communication interface. The communication interface may include a receiver component, a transmitter component, and/or a transceiver component. The communication interface may enable one or more of servers and terminals 110-140 to establish connections and/or transfer communications with other devices (e.g., a server, another device). The communications may be effected via a wired connection, a wireless connection, or a combination of wired and wireless connections. The communication interface may permit one or more of servers and terminals 110-140 to receive information from another device and/or provide information to another device. In some embodiments, the communication interface may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface may provide for communications with another device via a device-to-device (D2D) communication link, such as FlashLinQ, WiMedia, Bluetooth, ZigBee, Wi-Fi, LTE, 5G, and the like. In other embodiments, the communication interface may include an Ethernet interface, an optical interface, a coaxial interface, an infrared interface, a radio frequency (RF) interface, or the like.

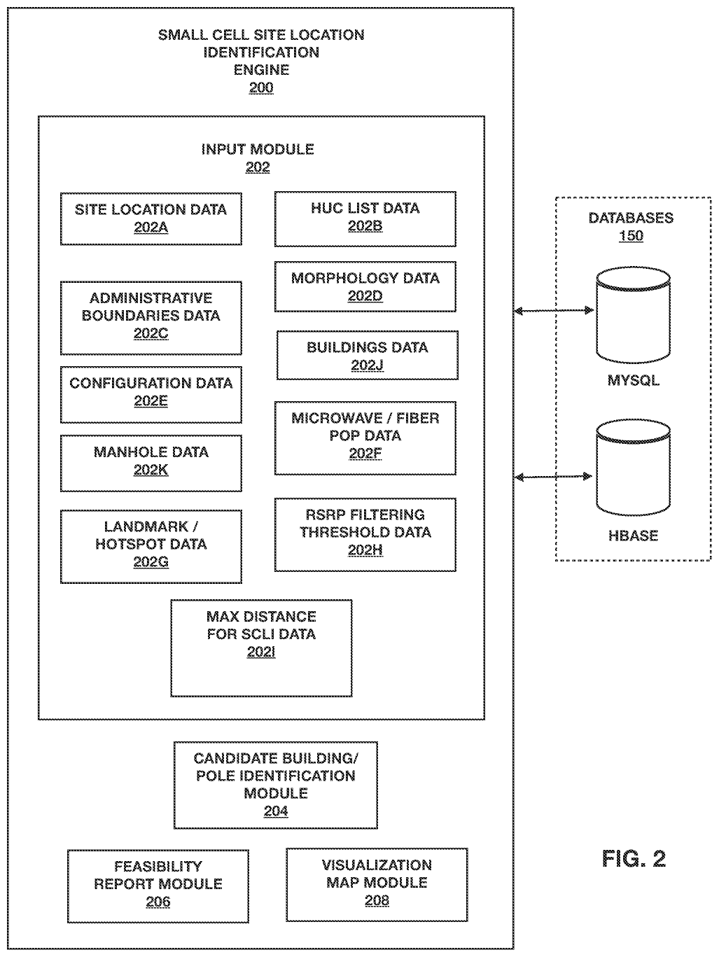

FIG. 2 is a block diagram of a system for identifying small cell site locations according to one or more embodiments. Referring to FIG. 1, the system includes an SCLI engine 200 in bidirectional communication with one or more databases 150, such as MySQL and Hbase. The SCLI engine 200 can include an input module 202 configured to provide input data and parameters to the SCLI engine 200 and algorithm disclosed herein. Here, input module 202 can further include sub-module input parameters or components for site location data 202A, highly utilized cell sample list (“HUC”) data 202B, administrative boundaries data 202C, morphology data 202D, and buildings data 202J, configuration data 202E, fiber point of presence (“POP”) and microwave data 202F, manhole data 202K, landmark and hotspot data 202G, reference signal received power (“RSRP”) filtering threshold data 202H, and max distance for small cell site location identification data 202I.

Still referring to FIG. 2, any of the input sub-modules 202A-202K can retrieve data therefrom or store data thereto databases 150, which can include among others, one or more MySQL databases, Hbase, or any other type of relational database management system (“RDBMS”). In particular, site location data module 202A can retrieve and receive input with respect to one or more or all sites and locations within a selected network, including site data such as latitude, longitude, azimuth, band details, extended cell global identification (“ECGI”) antenna height, and electrical tilt, among others, to be used by the SCLI engine 200. The HUC list data 202B can include a list of the HUC samples within a pre-defined or user defined period of time to be used by SCLI engine 200. As used herein, an HUC can be any cell macro-cell, small cell, or otherwise, such as a macro-cell or base station that is highly utilized within a network, has above average utilization or traffic within a network, has a degree of utilization that is above a pre-defined utilization parameter, or has a degree of utilization that meets or is above an industry recognized standard with respect to network cell utilization. Further, any type of algorithm, engine, process, or application may be used to identify the HUCs within the list with respect to sub-module 202B.

Still referring to FIG. 2, administrative boundaries data sub-module 202C can include various geographical boundaries to be used by the SCLI engine 200. Morphology data sub-module 202D can include various geographic area morphologies (e.g., dense urban, sub urban, urban, rural, etc.) and buildings data sub-module 202J can include various building or structure data (e.g., location, size, height, etc.) to be used by the SCLI engine 200, wherein modules 202D and 202J each receive data from different data sources. Configuration data sub-module 202E can include various types of configuration data within a network to be used by the SCLI engine 200. Microwave and Fiber PoP or fiber-optic network data sub-module 202F can include site and location related information pertaining to fiber PoPs/fiber-optics s to be used by the SCLI engine 200, including microwave data, XPIC site data, microwave links, and microwave radio transmission. Manhole data sub-module 202K can include various types of information, including location information, pertaining to manholes or manhole covers having antennas for signal propagation. Landmark and hotspot data sub-module 202G can include various site related location data pertaining to various types of city or regional landmark sites and known wireless hotspot sites to be used by the SCLI engine 200. Here, parameters pertaining to any of sub-modules 202A-202K may be pre-defined and retrieved from databases 150. However, it is contemplated within the scope of the present disclosure described herein that any of the data pertaining to sub-modules 202A-202K may also be user defined and configurable.

Still referring to FIG. 2, RSRP filtering threshold data sub-module 202H can provide configurable and user defined input parameters. In particular, in one exemplary embodiment, RSRP filtering threshold or condition can be configured, defined, predefined, or set to be less than a first (predetermined) threshold value (e.g., −95 dBm or (<−95 dBm)) or less than or equal to a first (predetermined) threshold value (e.g., −95 dBm (<=−95 dBm)) to be used by the SCLI engine 200. However, it is contemplated within the scope of the present disclosure that the RSRP filtering threshold can be set to any suitable value depending on the desired output of the SCLI engine and other network parameters, variables, and constraints. Maximum distance to small cell site location identification data sub-module 202I can allow the user to configure, define, or set a maximum distance for a small cell site location based on a calculated cell range or defined value for a particular morphology. TABLE 1 illustrates exemplary data for various types of morphologies and their associated maximum distances (which can be fixed values) which can further be used by the SCLI engine 200. By way of example, a distance for potential candidate small cell site locations with respect to planned or on-air macro cells can be configured at 156 m, wherein such candidate small cells can fall within or less than the 156 m distance of the planned or on-air macro cells.

TABLE 1

| MORPHOLOGY | DISTANCE | |
|---|---|---|
| Dense Urban | 500 | m |
| Sub Urban | 1250 | m |
| Urban | 800 | m |
| Rural | 800 | m |

Still referring to FIG. 2, the SCLI engine 200 can also include a candidate building and pole identification module 204 that can use any one or more of the input parameters within input module 202 and its associated sub-modules 202A-202K in order to identify candidate buildings and poles for small cell site deployment, which will be discussed later in this disclosure in more detail. In addition, SCLI engine 200 can also include a feasibility report module 206 that can output the results of the candidate small cell site locations to the user. In addition, SCLI engine 200 can also include a visualization map module 208 that can output and visually display via a GUI portal the identified candidate small cell site locations.

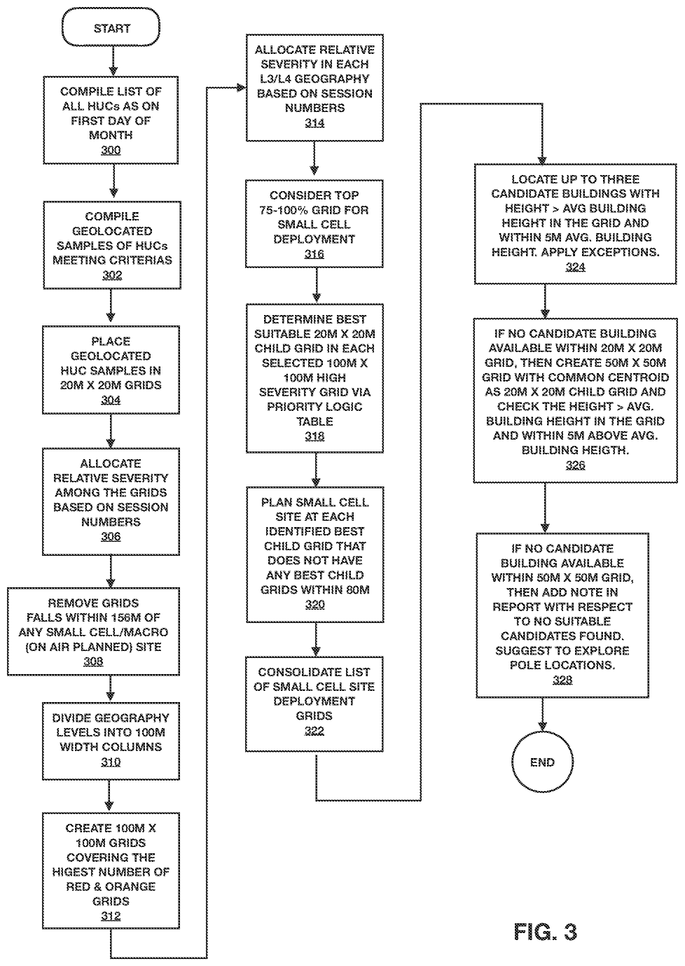

FIG. 3 is a flowchart of an SCLI engine system and method according to one or more embodiments. Referring to FIG. 3, at step 300, a list of one or more (e.g., all) HUCs within a network is retrieved/received and compiled. In one embodiment, the list can be of geolocated or geotagged samples of HUCs as of the first day of the month. At step 302, the list of the geolocated samples of the HUCs is compiled per one or more predetermined criteria, thresholds, or conditions. For example, a list of HUCs having less than or equal to −95 dBm (<=−95 dBm) RSRP and falling within a calculated Cell Range or range/distance defined (or fixed) in the SCLI planning settings, associated morphology distances, or input parameters within TABLE 1 may be compiled. Upon determining that any one or more of the geolocated HUC samples meet the foregoing conditions per step 302, then the process can proceed to step 304. At step 304, each of the determined geolocated HUC samples of step 302 is aggregated and placed within 20 m×20 m grids.

At step 306, various severity factors or levels may be designated, labeled, identified, and/or allocated for/to each of the samples within the 20 m×20 m grids based on the number of sessions or RSRP sample count, wherein the severity factors are each based on the level, rank, or degree of network congestion with respect to each HUC sample. For example, each grid can be designated, labeled, identified, and/or allocated with the following identifiers (“IDs”), each associated with a rank or degree of network congestion severity, based on the number of sessions or RSRP sample counts for each HUC sample or 20 m×20 m grids that fall within the following ranges: a) a first predetermined label ID (e.g., “red” label ID) for the top 75%-100% of grids, b) a second predetermined label ID (e.g., “orange” label ID) for the top 50%-75% of grids, c) a third predetermined label ID (e.g., “light blue” label ID) for the top 25%-50% of grids, and d) a fourth predetermined label ID (e.g., “dark blue” label ID) for the bottom 0%-25% of grids. The foregoing labels IDs a)-d) can be saved as a first set or a “Set A.” Here, it is contemplated within the scope of the present disclosure that any label ID or indicia may be associated with the grids having a number of sessions or RSRP sample counts that fall within a defined severity level or range that is not limited to any color and/r form.

Still referring to FIG. 3, after the severity levels have been designated at step 306, the process can proceed to step 308. At step 308, any 20 m×20 m grids that have a centroid which falls within the range of 0-156 m (or any other defined distance) of any small cell site or macro-cell location (planned and on-air) are removed. Next, at step 310, the geography level, such as at the L3 (e.g., prefecture) level or the city level (L4), is divided into 100 m width columns. At step 312, within each 100 m column of step 310, 100 m×100 m grids that cover the most or highest number of first predetermined label ID and second predetermined label ID 20 m×20 m grids are created. At step 314, the process can again designate, label, identify, or allocate the following IDs associated with each level of severity or the severity factors among the 100 m×100 m grids in each L1/L3 geography (or with respect to geographic locations) based on the number of samples or sessions or RSRP count, wherein the severity factors, ranks, or degrees are further based on network congestion traffic: e) a fifth predetermined label ID (e.g., “red” label ID) for the top 75%-100% of grids, f) a sixth predetermined label ID (e.g., “orange” label ID) for the top 50%-75% of grids, g) a seventh predetermined label ID (e.g., “light blue” label ID) for the top 25%-50% of grids, and g) an eighth predetermined label ID (e.g., a “dark blue” label ID) for the bottom 0%-25% of grids. The foregoing labels IDs e)-g) can be saved as a second set or a “Set B.” At step 316, the top 75%-100% grids or the fifth predetermined label ID (e.g., “red” label ID) grids of step 314 are analyzed, considered, and determined from the second set or Set B for small cell site location deployment. At step 318, the process can find and determine the best or most suitable 20 m×20 m child grid or sub-grid in each of the 100 m×100 m high severity grids via a Priority Logic Table, such as shown in TABLE 2. With respect to TABLE 2, it is contemplated within the scope of the disclosure herein that the priority, weightage, or weight assignments can vary based on the availability of parameters provided, for example, by a network provider.

TABLE 2
Priority Logic Table for Best Child Grid (20 m × 20 m) Selection within 100 m × 100 m Grid

| PRIORITY | | | MAX | PRIORITY | OVERALL | OVERALL |
|---|---|---|---|---|---|---|
| TYPE | PARAMETER | CRITERIA | WEIGHT | SCORE | WEIGHT | PRIORITY |
| RF | No. of | Own Grid | 3 | (A × 3) + | 70.00% | (RF |
| Priority | Buildings | Building Count/ | | (B × 3) + | | Priority |
| | | Best Grid | | (G × 2) + | | Score × |
| | | Building Count = A | | (H × 2) | | 0.7) + |
| | No. of | Own Grid | 3 | | | (Tx |
| | Landmarks | Landmark Priority | | | | Priority |
| | | Score/Best Grid | | | | Score × |
| | | Landmark Priority | | | | 0.3) |
| | | Score = B | | | | |
| | Unique | Own Grid User | 2 | | | |
| | No. of | Count/Best Grid | | | | |
| | Users | User Count = G | | | | |
| | No. of | Own Grid | 2 | | | |
| | Sessions | Sessions Count/ | | | | |
| | | Best Grid | | | | |
| | | Sessions | | | | |
| | | Count = H | | | | |
| | Max RF Priority Score: | | 10 | | | |
| Transmission | XPIC MW | Line of sight | 3 | (D × 3) + | 30.00% | |
| (Tx) | Site | (“LOS”) with any | | (E × 4) + | | |
| Priority | | first nearest CSS- | | (F × 3) | | |
| | | XPIC Microwave | | | | |
| | | Site (Yes = 1, | | | | |
| | | No = 0) = D | | | | |
| | Fiber | LOS with any first | 4 | | | |
| | POP | nearest CSS-Fiber | | | | |
| | | Site (Yes = 1, | | | | |
| | | No = 0) = E | | | | |
| | Fiber | <100 m from | 3 | | | |
| | Manhole | Centroid (Yes = 1, | | | | |
| | | No = 0) = F | | | | |

| | |
|---|---|
| Max Tx Priority Score: | 10 |

Still referring to FIG. 3, once the best or most suitable 20 m×20 m child grid in each of the 100 m×100 m high severity grids is determined via the Priority Logic Table of TABLE 2 and step 318, then the process can proceed to step 320. At step 320, the process can plan small sell site locations or candidate locations at each identified best child grid that does not have any best child grids within 80 m or any other defined or predefined distance. In particular, all the grids that do not fall within the 80 m radius (or other predefined distance) of all other 20 m×20 m child grids and have a higher priority (as determined via TABLE 2) will be marked as the best child grid(s). However, If multiple grids fall within the 80 m radius (or other predefined distance) and have the same priority (as determined via TABLE 2), then the process can randomly select the grid and mark as the best child grid(s) for small cell deployment. After step 322, the process can consolidate a list of the small cell site location deployment girds based on the best 20 m×20 m best child grids determined from step 320. At step 324, the process can determine, locate, and identify up to three candidate buildings or structures that have a height which is greater than an average building height within each best 20 m×20 m child grid and within 5 m of the average building height. In addition, at step 324, the process can also apply certain exceptions (if any) with respect to a pre-defined list of buildings or areas to exclude, which can include schools, restricted areas, military and defense areas, or airports, among others, depending on the user or vendors configurations, and further move to step 326. At step 326, if no candidate buildings are available within the best 20 m×20 m child grid(s), then the process can create one or more 50 m×50 m grids having as common (or same) centroid as of the 20 m×20 m child grid and check whether the height is greater than the average building height in the grid and within 5 m (or any predefined distance) above the average building height. At step 328, if no candidate buildings are available within a 50 m×50 m grid (having a common centroid as of the 20 m×20 m child grid), then a notation can be added in the final report or on the outputted GUI map with respect to no suitable candidate(s) being found to propose small cell site locations, and suggesting the user to explore pole or post locations, and the process may end.

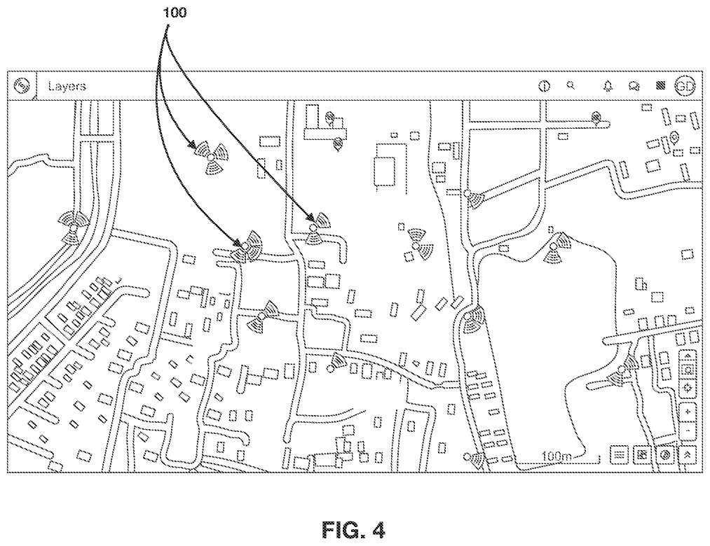

FIG. 4 illustrates one non-limiting exemplary embodiment of cells 100 (such as the identified small cell site locations) displayed with respect to their identified site locations via the foregoing SCLI engine system and method of one or more embodiments on a Graphical Information System (“GIS”) or GUI portal map view. Specifically, identified cells 100 on the maps of FIGS. 4-7 can represent candidate outdoor spaces, structures, or buildings for which small cells can be deployed by a radio access network provider.

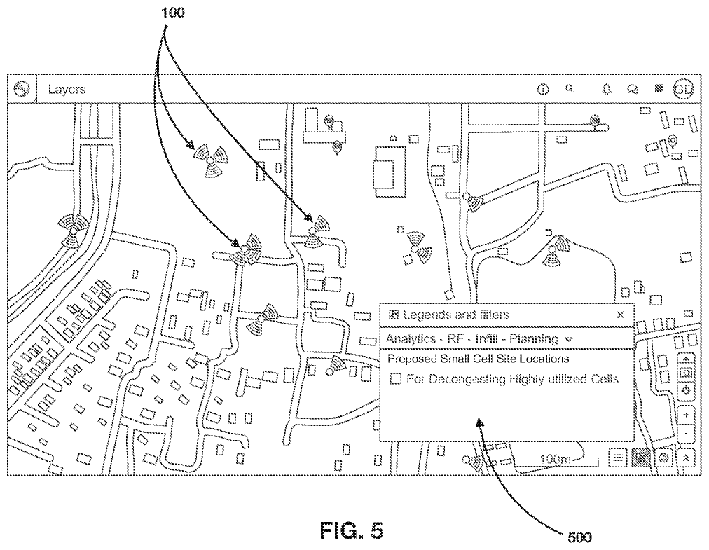

FIG. 5 illustrates another non-limiting exemplary embodiment of cells 100 (such as the identified small cell site locations) with respect to their identified site locations via the foregoing SCLI engine system and method on a Graphical Information System (“GIS”) or GUI portal map view. Here, the SCLI system and method can also display a legend and additional filters 500 with respect to the GUI portal map view. For example, the user can select a filtering element on the GUI that can show small cell site locations on the map that can be used for decongesting or offloading HUCs.

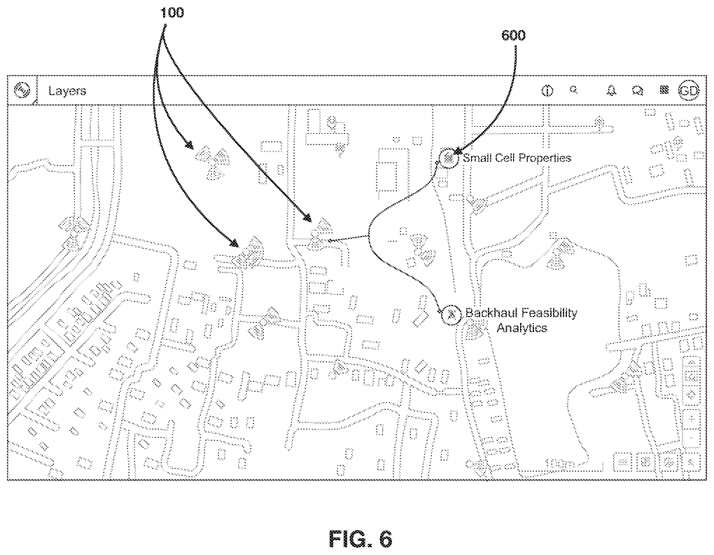

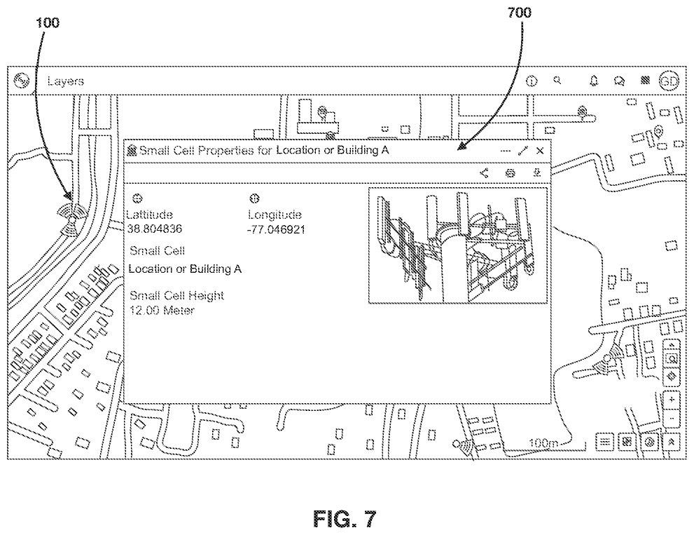

FIG. 6 illustrates another non-limiting exemplary embodiment of cells 100 (such as the identified small cell site locations) displayed with respect to their identified site locations via the foregoing SCLI engine system and method on a Graphical Information System (“GIS”) or GUI portal map view. Here, if the user selects any of the cells 100 on the GUI portal map view, then the SCLI system and methods of one or more embodiments described herein can also display an expanded “spider” view 600 of that particular selected cell. The expanded view display can allow the user to view the various properties or parameters that are pertinent to the selected cell and cell site location, including but not limited to various small cell properties and backhaul feasibility analytics. If the user further selects one of the expanded properties within the GUI portal, such as “Small Cell Properties,” then the user can be taken to the GUI portal of FIG. 7.

FIG. 7 illustrates a GUI window element 700 that displays various properties pertaining to the selected small cell site location, such as longitude/latitude data and height for the small cell, including a photograph of the location, building, pole, or post for the suggested small cell site location for deployment. Here, with respect to any of FIGS. 4-7, such outputted visual data and reports may be stored within a database and the user can download any data, report, or map from within any of the GUI portals.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method of identifying cell site locations within a cellular network, comprising:
receiving a list of one or more first cells with respect to a network;
applying a first set of conditions with respect to the first cells;
identifying the first cells that satisfy the first set of conditions;
placing the identified first cells within one or more first grids;
designating one or more first network congestion severity identifiers to the first grids;
determining if a centroid of one or more grids within the first grids fall within a first pre-defined distance;
creating one or more first tables or matrices based on the designated first network congestion severity identifiers with respect to the first grids;
designating one or more second network congestion severity identifiers to the first tables or matrices; and
identifying, based on the second network congestion severity identifiers, the first tables or matrices for cell site location identification.

2. The method of claim 1, wherein the first tables or matrices are further based on geographic regions, locations, or levels.

3. The method of claim 1, wherein the first cells comprise macro cells within the network.

4. The method of claim 1, wherein the first network congestion severity identifiers and second network severity identifiers are each comprised of a first rank or degree having a range of 75%-100%, second rank or degree having a range of 50%-75%, a third rank or degree having a range of 25%-50%, and a fourth rank or degree having a range of 0%-25%.

5. The method of claim 4, wherein the identifying, based on the second network congestion severity identifiers, the first tables or matrices for cell site location identification, comprises identifying, based on the first rank of the second network congest severity identifiers, the first tables or matrices for cell site location identification.

6. The method of claim 1, further comprising:
determining one or more first sub-grids from each of the first tables or matrices based on priority within the network.

7. The method of claim 6, further comprising:
upon determining the one or more first sub-grids from each of the first tables or matrices based on priority within the network, identifying one or more cell site location candidates within the one or more first sub-grids.

8. The method of claim 7, wherein the identified one or more cell site location candidates do not fall within a predefined distance.

9. The method of claim 8, further comprising consolidating a list of the identified one or more cell site location candidates within the one or more first sub-grids; and
identifying one or more candidate structures from the consolidated list having a height greater than an average structure height.

10. The method of claim 6, wherein the priority is further based on a priority score comprised of a weighted radio frequency priority score and weighted transmission priority score.

11. An apparatus for identifying cell site locations within a cellular network, comprising:
a memory storage storing computer-executable instructions; and
a processor communicatively coupled to the memory storage, wherein the processor is configured to execute the computer-executable instructions and cause the apparatus to:
receive, from a central server, a list of one or more first cells with respect to a network;
apply a first set of conditions with respect to the first cells;
identify the first cells that satisfy the first set of conditions;
place the identified first cells within one or more first grids;
designate one or more first network congestion severity identifiers to the first grids;
determine if a centroid of one or more grids within the first grids fall within a first pre-defined distance;
create one or more first tables or matrices based on the designated first network congestion severity identifiers with respect to the first grids;
designate one or more second network congestion severity identifiers to the first tables or matrices; and
identify, based on the second network congestion severity identifiers, the first tables or matrices for cell site location identification.

12. The apparatus of claim 11, wherein the first tables or matrices are further based on geographic regions, locations, or levels.

13. The apparatus of claim 11, wherein the first cells comprise macro-cells within the network.

14. The method of claim 11, wherein the first network congestion severity identifiers and second network severity identifiers are each comprised of a first rank or degree having a range of 75%-100%, second rank or degree having a range of 50%-75%, a third rank or degree having a range of 25%-50%, and a fourth rank or degree having a range of 0%-25%.

15. The apparatus of claim 14, wherein the computer-executable instructions, when executed by the processor, further cause the apparatus to identify, based on the first rank of the second network congest severity identifiers, the first tables or matrices for cell site location identification.

16. The apparatus of claim 15, wherein the computer-executable instructions, when executed by the processor, further cause the apparatus to:
determine one or more first sub-grids from each of the first tables or matrices based on priority within the network.

17. The apparatus of claim 16, wherein the computer-executable instructions, when executed by the processor, further cause the apparatus to:
upon determining the one or more first sub-grids from each of the first tables or matrices based on priority within the network, identify one or more cell site location candidates within the one or more first sub-grids.

18. The apparatus of claim 17, wherein the identified one or more cell site location candidates do not fall within a predefined distance.

19. The apparatus of claim 18, wherein the computer-executable instructions, when executed by the processor, further cause the apparatus to:
consolidate a list of the identified one or more cell site location candidates within the one or more first sub-grids; and
identify one or more candidate structures from the consolidated list having a height greater than an average structure height.

20. A non-transitory computer-readable medium comprising computer-executable instructions for identifying cell site locations within a cellular network by an apparatus, wherein the computer-executable instructions, when executed by at least one processor of the apparatus, cause the apparatus to:
receive a list of one or more first cells with respect to a network;
apply a first set of conditions with respect to the first cells;
identify the first cells that satisfy the first set of conditions;
place the identified first cells within one or more first grids;
designate one or more first network congestion severity identifiers to the first grids;
determine if a centroid of one or more grids within the first grids fall within a first pre-defined distance;
create one or more first tables or matrices based on the designated first network congestion severity identifiers with respect to the first grids;
designate one or more second network congestion severity identifiers to the first tables or matrices; and
identify, based on the second network congestion severity identifiers, the first tables or matrices for cell site location identification.
